(19) United States
(12) Patent Application Publication
(10) Pub. No.: US 2011/0103586 A1
(43) Pub. Date: May 5, 2011

(54) System, Method and Device To Authenticate Relationships By Electronic Means

(76) Inventor: Tácito Pereira Nobre, Sao Paulo (BR)

(21) Appl. No.: 12/986,574

(22) Filed: Jan. 7, 2011

Related U.S. Application Data
(63) Continuation of application No. PCT/BR2009/000196, filed on Jul. 6, 2009.

(30) Foreign Application Priority Data
Jul. 7, 2008 (BR) PI0802251-8

(51) Int. Cl. H04L 9/32; H04K 1/00

(52) U.S. Cl. 380/270; 713/156

(57) ABSTRACT

The present invention is in the Information Technology field, specifically in the authentication of systems' users by using wireless remote communication technologies and refers to a system, a method, and a device capable of authenticating users and providers of centralized services, safely and reciprocally. More specifically, the invention's field of application is that of methods of management of people authenticating processes, in their relationships through digital electronic means.

### CROSS REFERENCE TO RELATED APPLICATIONS

This patent application is a continuation under 35 U.S.C. §111(a) of international patent application PCT/BR2009/000196, filed Jul. 6, 2009. Priority to the aforementioned application is claimed under 35 U.S.C. §120. The entire disclosure of PCT/BR2009/000196, as published in international publication WO 2010/003202 A2, is hereby incorporated by reference into this patent application. In addition, priority is claimed under 35 U.S.C. §119 to Brazil patent application PIO802251-8, filed Jul. 7, 2008. The entire contents of the aforementioned application is incorporated herein by reference.

### BACKGROUND OF THE INVENTION

1. Field of the Invention

The present invention is in the Information Technology field, referring specifically to the authentication of users of systems by using wireless remote communication technologies and refers to a system, a method and devices capable of authenticating users and centralized services providers, safely and reciprocally.

More specifically, the invention's field of application is that of the management of people authentication methods, in their relationships through digital electronic means, such as the Internet, for example to perform bank and credit card transactions, or even performing any other activities that involve the need of connecting to a central server to request services, authorization of transactions of any kind or also the digital signature of documents existing in the form of digital files, or even via bank terminals and POS (Point-of-sale), or even by microcomputers, or simple terminals, with access to systems centralized in servers, or in Intranets used by any kind of organization or company for their internal working systems, or even making effective transactions of any kind through landline phones or mobile phones.

2. State of the Art

The management methods to authenticate people are intended to guarantee that a person who wishes to establish a relationship, or perform a certain electronic digital transaction, actually is who he/she says he/she is, so that the person will be allowed to access the resources or carry out the transactions for which he/she has been granted a previous authorization.

Therefore, the mentioned methods intend to reduce frauds in the use of personal identity information, personal passwords, bank account and credit card numbers. Such fraud results from the theft of information, via the Internet, by using techniques such as keylogging, spyware, phishing, man-in-the-middle, or skimming in the case of access to ATMs (Automatic Teller Machines) or self-service terminals, as well as physical theft of bank cards, credit cards, or personal identification cards.

Such methods normally require that users authenticate themselves to the systems with which they have an electronic relationship, supplying the following type of elements:

1) Personal information belonging to the user which is publicly accessible, although typically in a restricted manner, such as a current account number, a credit card number, an insurance policy number, a user ID or an e-mail account.

2) Information of the user's exclusive knowledge, such as a password, or a certain secret phrase.

3) A physical element of the user's exclusive ownership, such as a card with a magnetic strip, a Smart Card that communicates wirelessly or by physical contact, a Subscriber Identity Module (“SIM”) card used in cellular phones, a token that generates passwords valid only once (one-time passwords), an offline reading device that, when it has a Smart Card inserted in it, supplies passwords valid only once (one-time passwords), or a card with printed passwords associated with positions identified numerically.

4) Information physically contained in a card, legible by its owner, such as an embossed code, its expiration date, or code printed on a strip on the back thereof.

5) Information chosen randomly, and digitally signed, by means of a HASH calculation procedure thereof, and subsequent encryption thereof with a secret key, such key of common and exclusive ownership between the user and the organization's central server. The secret key and the procedure herein described are kept within a Smart Card of the user's exclusive use.

6) Information of the user's exclusive ownership and access, such as a private key stored in a Smart Card or token, which has its corresponding public key stored in a digital certificate of public availability and possible to be recognized as valid by the central server. The Smart Card or token will only be activated by supplying it a PIN (Personal Identification Number), a number known and used exclusively by the user, so that the consecutive supply of a PIN number different to that originally registered by the user (usually after three times) blocks the Smart Card and makes it inoperative. Additionally, the private key contained within the Smart Card is such that it will never be able to leave the interior of the Smart Card. The receipt by the central server of a digitally signed message using the private key contained in the Smart Card, and after the successful verification that the former is authentic, using the public key contained in the user's digital certificate, having accepted this as valid by the trust given to the Certification Authority that signed it, it will allow the organization to recognize that the person in possession of the Smart Card, and with whom it is having a relationship by electronic means, actually is the person whose identification data is contained in the corresponding digital certificate.

7) Information of biometrical nature obtained from elements of the user's organic constitution, such as his/her finger prints, shape of his/her hands, shape of his/her face, design of his/her iris or his/her DNA.

At present the authentication is typically carried out in the following ways, depending on the situation:

a) In Presential Relationships with Bank Cards or with Credit Cards

The authentication is carried out by presenting a card owned by the user containing only a magnetic strip or a Smart Card also containing a magnetic strip. Such card contains a bank account number or a credit card number, or an insurance policy number or a user ID number (information of public nature).

The card is inserted in a POS or ATM reader that is part of the network or system belonging to the organization with which the person wishes to have a relationship and then, according to the case, the person also enters a password that is of his/her exclusive knowledge.

The risks of fraud in these cases occur when a bank or credit card that only uses a magnetic strip is stolen or cloned, where the hacker does not need to know a password, as in the case of credit cards; or otherwise obtains it by means of a device that, attached to an ATM or POS, is capable of gathering information of the account number and password, without the knowledge of the user owner of the card or the institution to which these terminals belong.

The organizations that issue credit cards must maintain constant monitoring systems of purchases performed with the cards so that, when they detect purchases that are out of usual pattern of transactions performed by the person, or some other defined criteria, it alerts a group of attendants who, by telephone, try to contact the card owner to confirm transactions and, depending on the case, do actually block the card even without the owner's approval, if they do not manage to contact him/her.

When the cards are of the Smart Card type, the risk is substantially reduced, since the password information is stored in the card's chip, which is only read in a controlled manner by the ATM, POS device or card reader belonging to the organization with which the person has a relationship, so as to be compared with the password entered by the user who presents the card to perform the transaction.

Currently many banks already supply this kind of chip-containing card to their clients For example, there are VISA and MASTERCARD cards which meet this description and which operate with an internal standard architecture defined by Europay, MasterCard and Visa, called EMV (which stands for Europay, MasterCard and Visa).

The architecture of EMV standards comprises the use of Smart Cards with a simple processor, the EMV standard level 1, or also with two processors, this one with the capability for cryptographic calculations, the EMV standard level 2.

The purpose of adopting these standards was to reduce frauds in transactions carried out through POS terminals with the physical insertion of the smart cards in the terminals, which now must read the cards with chips, in addition to the traditional ones with magnetic strip.

In Brazil, nearly every POS terminal, as well as card reading terminals, connected to shop or supermarket cash registers, as well as ATM, have already been converted to have this capability, and the same is happening also in many European countries. In the United States currently, however, practically the entire transactions acquisition network still remains with the capability of only reading the magnetic strip of cards.

The EMV standard level 1, which uses an authentication system called SDA (Static Data Authentication), was conceived and intended for situations where transactions occur at terminals connected on-line to central servers and the EMV standard level 2, which uses an authentication system called DDA (Dynamic Data Authentication) for transactions that occur off-line.

A DDA type authentication requires Smart Cards with a co-processor capable of cryptographic calculations, while the SDA type authentication requires simpler Smart Cards, without this feature.

The standard currently mostly used as a result of the telecommunication network growth is the EMV level 1 that, effectively, has already brought a significant reduction in the level of frauds, as shown by the CHIP & PIN program already implemented in England for approximately four years.

b) In Non-Presential Relationships with Banks, Via Internet

In relationships with banks, authentication occurs by entering the current account number and, then, a specific password, different from that associated with the bank card, using a virtual keyboard and, additionally, eventually as an option of the bank, also a secret phrase exclusively known by the user. Then additional information is requested, which can be a code associated with a certain position of a card previously furnished by the bank, of its client's exclusive use and knowledge, or a password to be obtained from a token, which changes at determined short time intervals.

Some banks also use systems that supply a number that must be entered in a device that, in turn, will show an answer number on its display, which then must be entered by the user in his/her access computer.

Such authentication procedures are becoming ever more complicated with time, both for the institutions and their clients/users, with the objective of reducing the risks of fraud resulting from techniques with which the hackers, by disguised processes, try to capture the elements requested for users' authentication.

The adoption of these procedures reduced a lot of the risks of fraud but, on the other hand, it very much complicates life for clients/users and banks, with the simultaneous increase of its associated costs. Additionally, as the authentication continues occurring through information furnished by the PC connected to the Internet and as the hackers always continue, by means of persuasive tricks, trying to get people to “click” on attractive http (hypertext transfer protocol) links in order to introduce a spy program in peoples' machines and thereby try to gather information that allows the hackers to impersonate the user and carry out banking frauds, some risk of fraud still remains.

In these relationships, typically, the bankcard is not used to read and obtain data by the computer used to access to the Internet, regardless of whether it is or is not of the Smart Card type. Thus, the benefits attainable by the adoption of the technology of Smart Cards of the EMV standard, which are very efficient in preventing frauds in face to face transactions, could not be extended in a practical way to the Internet.

Some banks developed applications using digital certificate technology, with storage in a Smart Card having a cryptographic co-processor.

In this type of solution the user authentication is typically carried out by a decentralized challenge/answer process between the environment to which the card reader is directly connected and the Smart Card inserted in it, following a procedure, as that typically established by FIPS 196 standard. The great variety of PCs, operational systems, and types and versions of browsers, each requiring specific software for each card and Smart Card reader manufacturer showed, however, that a large amount of human technical support would be required to adapt the operation of these initiatives, making them of low practical feasibility, although extremely safe.

The document “Secure Internet Banking Authentication”, IEEE Security & Privacy 1540-7993/06-2006, Hiltgen at al proposes one taxonomy of Internet banking authentication methods and classifies them according to their resistance against offline credential-stealing and online channel-breaking attacks. In addition, it proposes two solutions, one based on short-time passwords and one on digital certificates.

c) In the Non-Presential Purchasing Relationships with Credit Cards by the Internet

In these cases the card number and some other information contained therein, such as expiration date, the safety code written on the back of the card, as well as the owner's name as written on the card, are furnished with the purpose of guaranteeing that the card is in the purchaser's hands, assuming that he/she is actually the card's owner. This procedure, however, does not manage to cover situations where the card has been physically stolen, or when this information has been illegally captured by third parties when sent by the Internet, or furnished by telephone or fax in transaction processes by these means, or even when the card has been in third parties' hands, such as a waiter of a restaurant.

Another procedure that has been used is that of companies that render the service of collecting payments through debits on credit cards and then passing it onto the company that performed the sale via Internet, such as PayPal or Money brokers. In this case the person needs to open an account at one of these service renderers, using his/her e-mail as a user id and defining a password of his/her exclusive use and some additional information of his/her exclusive knowledge.

In these relationships, as in the case of banking transactions, the cards are not read directly by the PC, only being used to gather information from them necessary to carry out the transactions via Internet, also regardless in this case of whether it is a Smart Card or not.

Current surveys, for example the UK ABACS yearly surveys, indicate that it is in this type of relationship that frauds and losses occur with greater intensity for the entire system of credit cards in use.

With the purpose of trying to collect benefits from the use of cards of the Smart Card type with the EMV standard, MasterCard developed and made available a technological process called CAP (Chip Authentication Program), which requires the use of a small device with a keyboard and a display, in which the client inserts the Smart Card, and that must be activated and maintained as a reference during his/her transaction via Internet.

The base of this process is, on one hand, a central server maintained by the bank issuing the credit card and, on the other, the requirement that user inserts his/her Smart Card in the device and activates it by entering his/her PIN. From this point on one alternative would be the generation of a numerical OTP (One Time Password) type password by the device, which the user then enters in the PC. Another one would be that of the central server generating a code shown on the PC's screen at the time of the transaction, which the client then must copy on to the device's keyboard, which, in turn, based on this number that is furnished to it, will calculate a new number, that appears on its small screen, which the client/user must then copy on to the PC's keyboard.

If the number entered is the same as that expected by the central system, the transaction will be authenticated as valid. This is a process that has already been adopted by some banks, in some European countries, but that, although efficient in preventing frauds, introduces a procedure that is not simple, and ends up requiring a lot from the clients/users.

d) New Alternatives in Evolution

The authentication strategies described in the previous items always try to use an authentication procedure based, at least, on two factors (Two Factor Authentication), typically a piece of information of the person's exclusive knowledge, such as a password or PIN, and something that is exclusively in the person's physical possession, such as a card or a device.

In October 2005, the FFIEC—Federal Financial Institutions Examination Council, that is part of the regulatory system of the United States Financial Sector, together with the Federal Reserve and the FDIC—Federal Deposit Insurance Corporation, published guidelines determining the use of authentication procedures based on two factors, initially establishing the end of 2006 as the last day for American banks to adopt them in their operations via Internet. The FFIEC did not, however, opt for any specific technology for implementation of the indicated procedures.

A study published by Forrester Research, written by Jonathan Penn, published in July 2006, analyzes and suggests various alternatives for banks to meet these requirements.

On the other hand, with the development and large scale adoption of mobile phones based on the GSM (Global System for Mobile Communication) technology, as well as, in a smaller scale, the adoption of short distance wireless communication technologies, such as Bluetooth, several initiatives and experiments regarding the use of these technologies appeared seeking to establish an alternative way, other than the Internet, to reach the user and establish an authentication procedure thereof.

Initiatives with the use of mobile phones occurred in simple formats, sending SMS messages to the user's mobile phone at the moment of carrying out his/her transaction with the bank, and waiting until he/she answers with another SMS message, confirming it. More elaborate formats existed in which the SIM card (Subscriber Information Module) small Smart Card present in the cellular phone was used to store a private key and a corresponding user digital certificate, thus creating the possibility of his/her authentication based on this technology using the SIM card. Additionally, software solutions were also made available that, when installed in a mobile phone, would allow their use also as a token generator of OTP (One Time Passwords), thus not requiring physical tokens.

Some Examples of the Initiatives Are:

1) The CASTING project (Smart Card Applications and Mobility in a World of Short Distance Communication), developed jointly by ETH Zurich and Swisscom AG Bern that, according to a publication of January 2001, created and implemented an authentication solution based on the use of the SIM card of a cellular phone, but only using the latter's capability of communicating via Bluetooth with a PC, which centralized every communication with the central server.

2) An Experiment of Mobile PKI (Public Key Infrastructure), conducted in England by a joint initiative of Vodafone, which is a mobile phone services operator, and G&D, which is a German manufacturer of Smart Cards.

3) The forming of a consortium in 1999, made up by companies such as Deutsche Bank, Ericsson, Matena, Microsoft, Sema Group, Siemens and TC Trust Center, with the objective of making the adoption of mobile signatures (signatures in mobile equipment) based on mobile phone SIM cards feasible.

4) The publication WO2005/041608—of the patent application “METHOD OF USER AUTHENTICATION” claiming user authentication method based on the use of SIM cards, with private key and digital certificate. This application has search report citing two other previous publications: WO02/19593—“SERVICE PROVIDER INDEPENDENT SAT-BASED END-USER AUTHENTICATION” and WO2003/0101345 “SUBSCRIBER AUTHENTICATION”.

5) Initiative developed by NIST (National Institute of Standards and Technology) reported in its publication NISTIR 7206, a piece entitled “Smart Cards and Mobile Device Authentication: An Overview and Implementation”, describing implementing a prototype solution that uses a Smart Card assembled in a card of multimedia format, called SMC (Smart Multimedia Card), fitted in the reader for this type of card existing in a PDA (Personal Digital Assistant) mobile device. Additionally, it discusses implementing a prototype of an independent device separate from PDA, and the former communicating with the latter via Bluetooth. It also discloses the capability of receiving the insertion of the SMC and proceeding with authentication with the PDA. SMC's are Smart Cards different from those of common use, in the form of plastic cards as those of banks or SIM cards of mobile phones, assembled in the form of multimedia cards, like the small memory cards used in mobile phones, PDA's, and photographic cameras.

6) Initiative of the mobile phone operator of Turkcell, which launched, in March 2008, an offer to its users so that when choosing to register at AND-Guven, Official Certificate Agency of Turkey, the users could have their usual SIM card replaced by another one with cryptographic capabilities, and thus be able to have their digital certificate generated in their own mobile phone, with support from Turkcell. Its intention was that, in this way, applications could be made available by banks and other entities for a safe user authentication, as well as for the implementation of applications requiring the generation of digital signatures by them.

Deficiencies that Still Persist in Current Solutions

Although the use of the EMV standard has already been a great advancement in preventing frauds in operations with the physical utilization of Smart Cards in POS or ATM devices, several situations still persist that require a solution that should, at the same time, be safe, practical, and economically feasible.

The Situations are as Follows:

1) In transactions with credit cards via the Internet, where the card is not present for the vendor, or in operations with credit cards that only have a magnetic strip, the high risk of frauds occurring still remains.

The CAP solution suggested by MasterCard, using the EMV standard, although it is efficient, represents a very complicated process to be followed by the bank's or credit card's client and has made banks very reluctant to adopt it.

On the other hand, OTP (One Time Password) solutions, available by means of specific tokens or by means of software running in cellular phones are only efficient in Internet banking transactions, and are not efficient at all in transactions with credit cards via Internet.

2) Solutions that seek a user's authentication through a secondary path to the Internet, represented by the access to him/her via the mobile phone networks, using the SIM card as a platform for the user's authentication, still presents two basic difficulties seen from the bank or card issuing financial institution point of view:

a) How to obtain, in a practical and feasible way, the guarantee that the pair of keys was safely and correctly issued to its client, and that the digital certificate was properly signed by a trusted certification authority.

b) There would be a loss of autonomy for the banks and credit card issuers, regarding this possible relationship channel with their clients, since the SIM cards would be a property of the mobile phone network operators. The mobile phones, by this alternative, would become a vital element in support of the relationship with their clients, with the authenticating system out of their control.

3) In the experimental solutions wherein a mobile device is connected via a mobile phone network, in which a Smart card different from the SIM card was used, it was of a special nature, different from the one currently used in large scale, in a multimedia format card. Therefore, although being able to be the issuing bank's property, it has characteristics that make the solution inefficient.

4) In solutions where digital certification technology was considered, the user's authentication process has always followed the standard defined by FIPS 196, where the authentication occurs at the terminal with which the Smart Card is connected, so that after the card proves to the terminal that it has within it the private key that is the pair of the certificate presented, the user's credentials contained in the certificate are then considered valid and used to identify him/her at the server with which the latter desires to connect.

In no authentication system solution found, was the fact that the user already maintains a relationship with the organization taken advantage of, so that, due to this, his/her digital certificate could have been previously stored in its central servers. This procedure would significantly facilitate the inverse process in which the central server needs, or desires to find the person and communicate with him/her authentically and safely.

5) In no solution found was the possibility considered of using WI-FI technology as a channel so that the organization's central servers would find and communicate authentically and safely with the users.

### SUMMARY OF THE INVENTION

With the growing increase of systems that allow people the remote access to carry out the most diverse transactions, typically via Internet, and with greater importance banking finance transactions or with credit cards, and considering the above indicated deficiencies in the solutions currently recognized, the present invention provides a system, a method and a device that allow the safe authentication of people in face of the organizations with which they desire to have a relationship, and at the same time reduce, to the minimum possible, the risk of a hacker obtaining their personal information and thereby performing frauds using it.

The adoption of a system with these characteristics will significantly increase people's trust in using the Internet, thereby allowing a concrete and firm base for a substantial expansion of electronic commerce with countless benefits for the economies of all countries.

### OBJECT OF THE INVENTION

The main scope of the present invention is to provide a system to authenticate people in their contacts by electronic means, with organizations with which they maintain a relationship, in order to meet the requirements that solve the above indicated deficiencies, i.e., safely, practically and comprehensively, including every possible form of remote electronic relationship.

Said scope is attained by means of the following objectives.

Provide a safe practice of users' authentication that is efficient, practical and economically feasible, in purchasing operations with credit cards via Internet, or in purchasing operations physically using a card at POS's or ATM's, when the card only has a magnetic strip, or the reading device is only able to read a magnetic strip (not information stored in a chip).

Provide a practice of authentication based on the use of a Smart Card whose contents are under full control of the bank or the institution that issues the credit card in favour of their clients, and that uses the facilities and safety of communication networks via GSM or 3G technology, or even still CDMA or TDMA, but only as a means of wireless transport and support of the relationship between the bank or institution and its user or client.

Provide a solution based on the use of Smart Cards having a standard format of regular use in the market, taking into account their availability and the feasibility of their issuing in large volumes by current systems, with the safe generation of cryptographic keys, which people are already used to carry and make use of.

Provide a solution where there is the most effective and efficient use of the users' digital certificates, using an architecture in which their keeping and use occurs so as to make the users' identification process as fast and practical as possible.

Provide a solution that uses all wireless communication technologies currently available, such as those based on GSM or 3G, or even CDMA or TDMA, or such as WI-FI, WIMAX, Bluetooth, NFC (Near Field Communication) and MYFARE.

Yet another objective of the present invention consists of the authentication system of people in relationships by electronic means with architecture, software and devices, to be a practical and simple solution to implement and use.

Yet another objective of the invention is to provide a system that can be used by organizations in their relationship not only with their clients, users and suppliers, but also with their own employees or direct collaborators.

Yet another objective of the invention is that it is economically feasible from the point of view of every party to whom it will be of use.

The stated objectives, as well as others, are attained by the invention through the provision of a system that allows individual users, who are in electronic communication with an organization with which they already have a defined relationship, to be authenticated and identified with the greatest safety possible.

Such electronic communications can be, for example, users' relationships in Internet banking operations, in purchasing operations with a credit card, both via the Internet as well as via POS (points of sale) networks, in operations at ATMs, or even between internal users of an organization via their private Intranet network.

Yet another objective of the invention is to provide a method that also will allow, when the case may be, obtaining jointly and simultaneously the user's safe authentication and, a safe and unequivocal register of his/her desire, for example, authorizing a debit transaction or digitally signing an electronic document, using for such processes and devices that make use of digital certification technology.

### General Description of the Invention

The invention includes adopting a Smart Card to be provided to every user to be used as his/her digital identification card before the organization with which he/she has a relationship.

The Smart Card will contain the private key of the user's exclusive use and his/her digital certificate, which has been signed by a certification authority trusted by the organization with which the user maintains a relationship. As the case may be, this role may be played by the financial institution or bank itself.

Therefore, the user's digital certificate will guarantee the safe bind between the user's public key and information that identifies him/her univocally for the organization, such as his/her ID number for the Internal Revenue Service, in case of Brazil, or an ID number of special meaning in a given country.

The technology for the Smart Card contents architecture, as the case may be, should be open and standardized, such as that established by the Global Platform organization, so as to allow, on one hand, the non-dependency on a sole supplier of Smart Cards and, on the other hand, the uploading of new applications to its interior after its original issue, understanding that this later uploading should occur under the management and control of the card's original issuing organization.

The invention is performed by the adoption of a new practice for the authentication of a user that carries a Smart Card containing a digital certificate that identifies him/her before the organization with which the he/she already maintains a defined relationship (for example, by means of a bank account or a credit card, a policy number, an identification number as employee, and other possible means), in which the digital certificate, previously registered in the organization's central server will allow the authentication process to be validated by the challenge/response method, initiated from the central server occurring directly between the latter and the Smart Card, and not anymore in a decentralized way, as is the practice currently used. This is one of the invention's essential characteristics.

The central server will send to the user's Smart Card a summary of the transaction desired by him/her, with a HASH calculated on it and digitally signed twice, first with the public key that belongs to the user, contained in his/her digital certificate previously stored in the organization's servers, and second with a private key belonging to the central server.

Once the summary and its HASH arrive with these signatures to the Smart Card's interior, the latter will decrypt and verify it with the user's private key and with the central server's public key, contained in the digital certificate belonging to the server, that will be also stored inside of the smart card, and if the result of this verification is correct, it will add to the summary the user's answer, yes or no, accepting or denying the transaction. After that, the smart card will calculate a new HASH and will sign it with the user's private key, and also with the central server's public key, sending this result back to the central server. The latter, when it receives the answer will decrypt and verify the received message, and if the result of this verification is correct, it will therefore obtain the user's authentication and the unequivocal register of his/her desire, confirming or not the transaction in question, thus guaranteeing evidence of non-rejection in relation to it. The double signature method will allow both parties, central server and user, to have their protection assured regarding an eventual fraud attempt by a third party.

Additionally, the invention adopts a new path for the relationship between the central server of the organization and the user's Smart Card, independent of the PC, terminal or POS through which the user submits his/her transactions by processes currently implemented. This path is implemented by connections with technologies, as the case may be, such as GPRS, 3G, WI-FI, WIMAX, Bluetooth, NFC or MYFARE.

The invention also comprises a new device and software necessary to its operation, such as safe interface with the user's Smart Card, by means of technology with or without contact, also having a keyboard to enter the PIN that will release the Smart Card for use, as well as for the user to state his/her acceptance or not regarding the transaction, and a small screen to display messages. The device will have the capability to establish a safe data communication with the organization's central server, by means of the technologies mentioned in the previous paragraph, and in addition also with the use of symmetrical encryption processes, where the symmetrical key used for this purpose will be unique for each client and communication session. The device may also have a USB port. The device will also have a format and size that will allow the user to take it with him/her practically, safely and simply.

As the mobile phones are made available in the market with the capacity to directly read standard size Smart Cards, as well as the SIM cards which already are normally available, the invention will make available the software necessary to these mobile phones, smart phones or palmtops, offered by the market's main suppliers, so that they may provide the same reading and communication functionality with the Smart Card containing the user's digital identification offered by the device mentioned in the previous paragraph, so that if the user wishes, he/she may use these handsets directly to validate his/her authentication and register his/her transaction acceptance or not.

If the user's mobile phone has the capacity for Bluetooth or NFC connections, the above mentioned device can connect with it using them, so that the mobile phone itself may serve to establish the connection with the central server by means of the GSM or 3G, or even CDMA or TDMA network.

Another possibility is the physical connection of the device to the user's mobile phone, through its USB port, so that, as described in the previous paragraph, the mobile phone will perform the connection with the central server. This alternative will also make use of USB ON-THE-GO technology.

The solution also comprises a system of auxiliary central servers which will perform the cryptography functions on behalf of an organization's central hosts, and additionally also perform the gateway function for the information exchange between the organization's central hosts and the Smart Card containing the user's digital identification. In this way the adoption of this new solution may be carried out with a minimum impact on the environment of the organization's current central hosts.

Additionally the solution provides a database structure and servers for storing the users' digital certificates, their access number via the mobile phone network, and their univocal identification code before the organization, for example in Brazil, their Id number for the Internal Revenue Service.

The solution may also include, if the case may be, servers and the proper software structure to perform the Certification Authority function, so that the organization may digitally sign the digital certificates issued to their users or clients.

Another very important feature of the invention is that its adoption may be gradual and, fundamentally with no alteration in the current authentication methods already adopted by organizations in their interfaces with the users through which they perform their transactions via POSs or ATMs, or via the Internet. A change would be made in the processes carried out in the central hosts of the organization, so that when they receive a transaction to be authorized, they will verify if the user already has a valid Smart Card with his/her digital identification, and if this is the case, the authentication procedure established by the invention will then be executed, which will result in an additional, much stronger, guarantee to the current authentication procedures practiced by the organization. This implementation strategy will certainly make possible a much easier gradual adoption of this new solution, with minimal interference in the current systems.

### BRIEF DESCRIPTION OF THE DRAWINGS

For a better understanding of the proposed invention, it is described below using the attached diagrams as a reference, where:

FIG. 1 shows a block diagram illustrating the basic architecture of the new invented system and its interface with the existing system of relationships by electronic means composed of (1) USER that establishes a relationship (11) with an organization through an interface (10) that could be anyone of those shown, (2) CENTRAL GATEWAY SERVER provided by the invention, (3) DATA BASE SERVER that will associate the USER's identification, his/her mobile phone or smartphone number and his/her digital certificate, (4) PERMANENT LINK between the central servers (12) of the organization and THE CENTRAL GATEWAY SERVER (2) provided by the invention, (5) services offered by a PUBLIC MOBILE OPERATOR NETWORK, (6) USER'S MOBILE PHONE OR SMARTPHONE, with a specific downloaded application software, Bluetooth enabled, (7) SPECIAL PURPOSE DEVICE, Bluetooth enabled, with specific embedded application software, holding in its interior the USER's smart card, (8) BLUETOOTH CONNECTION between the USER'S MOBILE PHONE OR SMARTPHONE (6) and his/her SPECIAL PURPOSE DEVICE (7), (9) the USER's actions to authenticate himself/herself, and to take a non-deniable responsibility for the requested transaction or event he/she submitted to the organization through the existing relationships by electronic means, by he/she reading the received prompt at his/her mobile phone or smartphone, keying in at the mobile phone or smartphone the PIN number of his/her smart card to activate it, and choosing YES or NO, and CONFIRMING his/her choice, (10) USER INTERFACE LEVEL to the existing system of relationships by electronic means offered by the organization being it, as the case may be, a POS at a merchant location, a PC through the Internet or Intranet, a fixed or mobile phone, a fax machine or an ATM, (11) USER's ACTION to request a transaction or event to the organization through the existing system of relationships by electronic means, (12) existing Central Servers of the Organization.

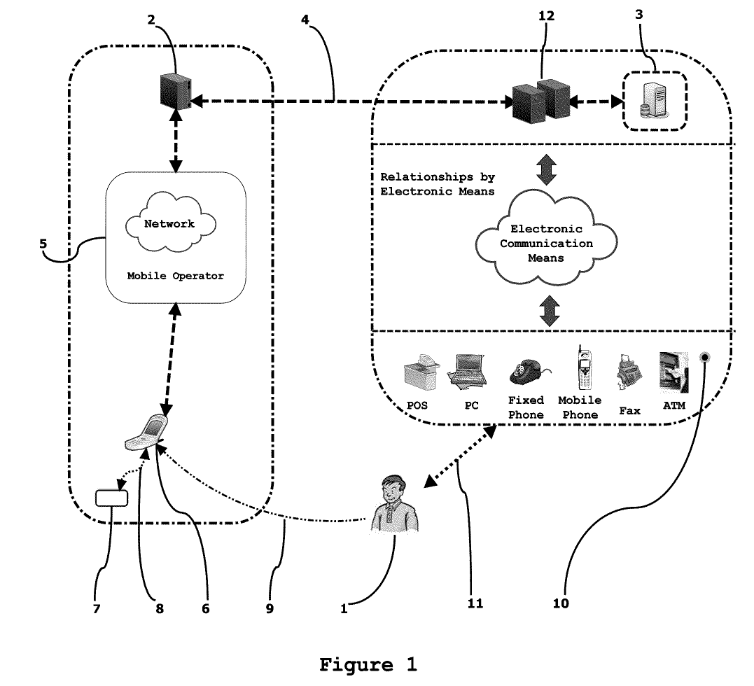

FIG. 2 shows a block diagram illustrating the application of the invented system regarding on line purchases through the Internet, at merchant web sites, using credit cards, composed by basically the same items as shown in FIG. 1, where at the user interface level only a PC is shown, the relationship by electronic means is represented by the Internet plus the merchant web server site, and the central servers of the organization are those of the credit card issuing organization.

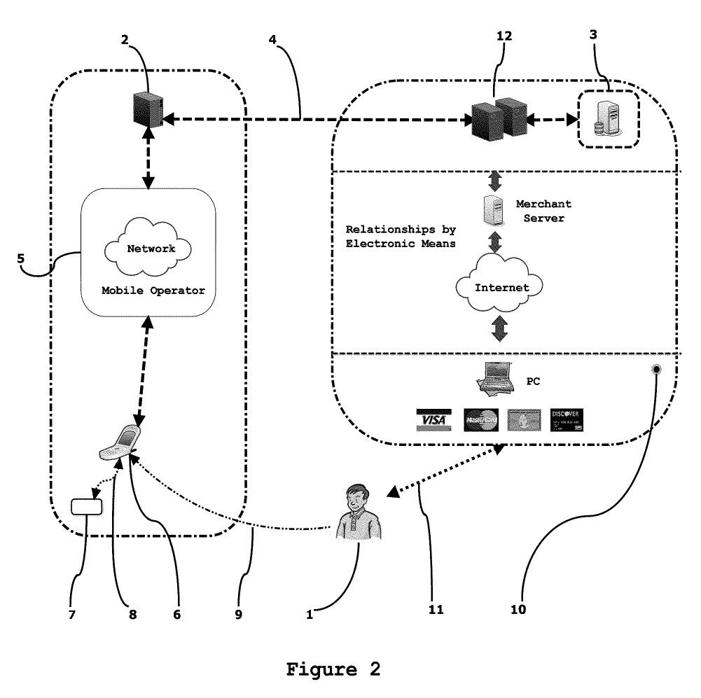

FIG. 3 shows a block diagram illustrating the application of the invented system to purchases at merchant stores using credit cards, composed by basically the same items as shown in FIG. 1, where at the user interface level only a POS is shown. The relationship by electronic means is represented by the Acquirer Network and the central servers of the organization are those of the credit card issuing organization.

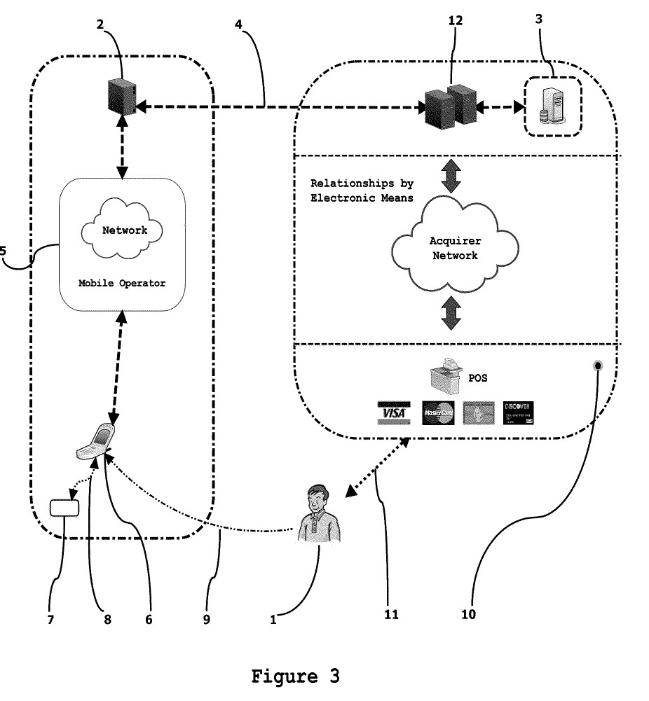

FIG. 4 shows a block diagram illustrating the application of the invented system to Stock Exchange Operations requested by telephone, composed of basically the same items as shown in FIG. 1, where at the user interface level only a fixed phone or mobile phone is shown, the relationship by electronic means is represented by (13) the Stock Broker receiving the purchase or sale orders through the telephone, registering them at the central servers of the organization, in this case those of the Brokerage firm, and inputting them at the (14) Stock Exchange Servers.

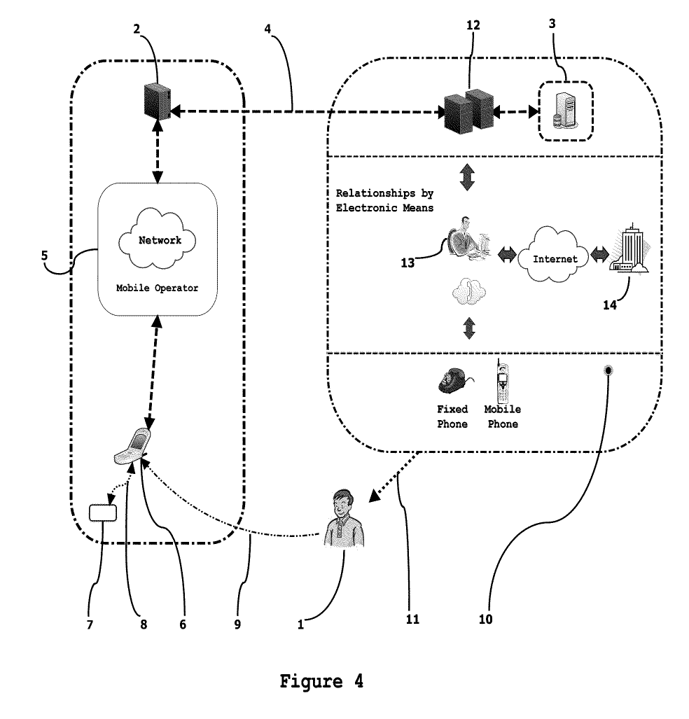

FIG. 5 shows a block diagram illustrating the application of the invented system to internal systems used by the organization, composed of basically the same items as shown in FIG. 1, where at the user interface level only a PC is shown, the relationship by electronic means is represented by the (15) Intranet of the organization, and the central servers of the organization are those for the processing of its own systems.

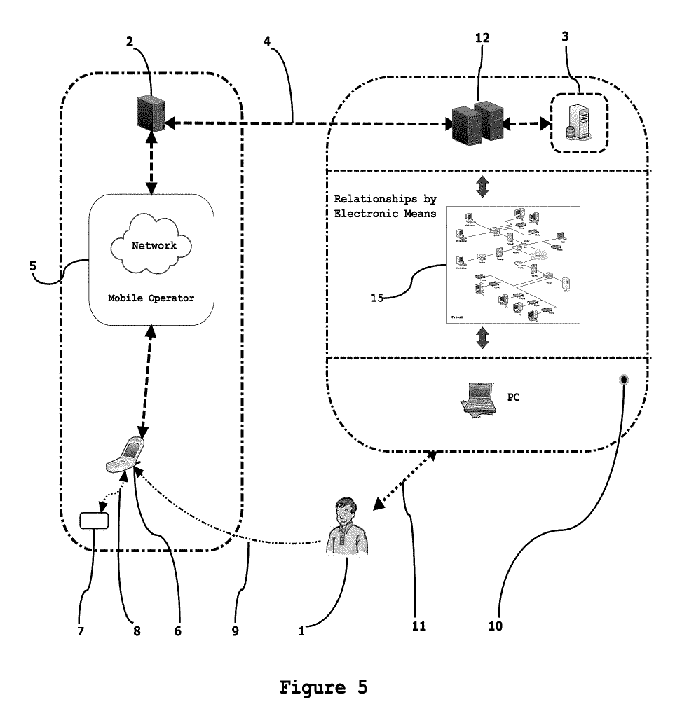

FIG. 6 illustrates a possible implementation of the (7) SPECIAL PURPOSE DEVICE, Bluetooth enabled, with a specific embedded application software, which holds in its interior the (16) USER's SMART CARD, and has (17) an ON/OFF button to be pressed by the USER to turn the device ON and OFF and (18) a LED that will signal to the USER that the device is ON or OFF.

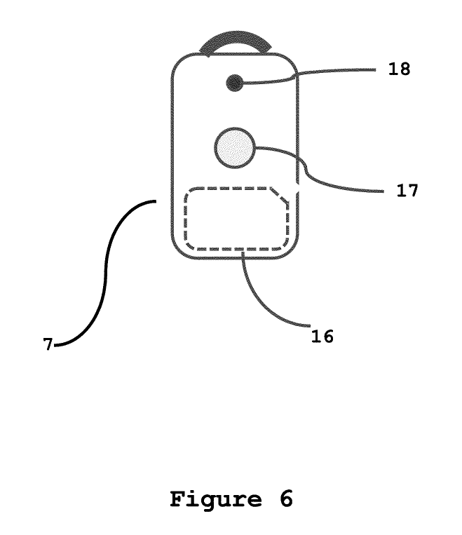

### DETAILED DESCRIPTION OF THE INVENTION

The user receives a digital certificate that has his/her corresponding private key stored in a Smart Card of his/her exclusive use. The smart card is made operational only through a validation process by means of a PIN (Personal Identification Number) number of the user's exclusive knowledge.

The digital certificate binds its public key to information that identifies the user in a unique way before the organization (for example, his/her Internal Revenue Service Registration number) and is digitally signed by a certification authority trusted by the organization, which may be the latter itself.

He/she also receives a special purpose device that will allow the exchange of information between the organization's central servers and the user's Smart Card, either directly through it, which will have in this case the capacity to act as a mobile device in a public Cellular Network, or with the assistance of a user's mobile phone having a Bluetooth service available, or yet having a USB On-THE-GO (OTG) service available, which will then be allowed at the sole user's discretion. If the user's mobile phone has in it the capacity of directly reading his/her Smart Card, the exchange of information between the organization's central servers and the user's smart card might take place with just the utilization of the mobile phone with this capacity, without the need of the mentioned device. This case is also an alternative foreseen by the invention.

The users' digital certificates are stored in the organization's central data bases, tied to information that identifies the user for the organization, plus other information that characterizes his/her relationship with it, such as an account number, a credit card number, policy number, for example. This is in addition to the information of the mobile number that will be used to establish the connection with the user's special purpose device or mobile phone.

The existing transaction interface processes regarding the relationship of the user with the organization via computers connected through the Internet, through POS terminals, or its Intranet, remain the same.

In all of these processes, at the step in which the user's transaction, which originated in his/her PC connected to the Internet or by means of a POS, reaches the organization's central host servers for approval, a small change introduced in the organization's central processes will check if the user does already have an enabled digital certificate and a client's smart card issued for him/her in accordance to the system foreseen by this invention. If he/she does, then the central host servers of the organization will produce a summary of the transaction and, together with a copy of the user's digital certificate, plus his/her mobile number, pass it on to the new cryptography and gateway servers provided by the invention, so as to obtain the secure user's authentication and confirmation of the transaction.

The cryptography and gateway servers provided by the invention will, in turn, generate a cryptographic challenge, including in the challenge a double digital signature of the transaction's summary, using the gateway server's own private key and the user's public key, which was included in the user's digital certificate received from the central host servers. The gateway servers then send, in sequence, a message to the user's special purpose device or mobile phone, to request his/her authentication and his/her acceptance of the transaction.

The user knowing beforehand that the transaction in question will require his/her explicit approval, using his/her certificate in his/her Smart Card, must turn on his/her special purpose device, and/or mobile phone and activate it by entering his/her PIN on his/her keyboard.

Once the message arrives at his/her special purpose device or mobile phone, it will be displayed on the screen, requesting the user to press one of two designated keys on the special purpose device or cellular phone for him/her to state his/her agreement or not with the transaction's data. The transaction's data basically includes the organization's identification, the transaction's date and value or nature of the transaction.

The user will have the option of pressing a YES key or a NO key. After the user presses his/her response, the system in the special purpose device, or mobile phone will request an action of the user's smart card by submitting the cryptographic challenge, plus the user's response, so that the smart card may perform the validation.

The Smart Card will then carry out the verification process of the signatures received and, adding to the decrypted summary the response provided by the user, it will generate, in turn, a new digital signature of the resulting package. The smart card then returns the result to the special purpose device or mobile phone in the user's hands.

The special purpose device or mobile phone, once it receives this answer from the smart card, will inform the user that it has received the result of the Smart Card action and will send his/her encrypted and digitally signed response to the organization's central servers.

In this way it will be sufficient for the user to choose YES, by pressing the corresponding key, so that this entire process occurs transparently and with no additional work for him/her, thus characterizing an extremely simple and practical procedure to be used.

The cryptography central servers, when they receive the user's response message, will verify the digital signature thereof generated by the Smart Card, and if it is correct, they will send to the central host servers an indication that the authentication was successful. The central host servers of the organization will then return to the remote points the transaction with its approval as requested by the user's desired transaction.

In the case of transactions with credit cards, it will be possible to include within the return message a copy of the character sequence that comprises the digital signature generated by the user's Smart Card, which will be the evidence of his/her transaction acceptance, so that his/her graphic manual signature will no longer be necessary, as is currently required in the art.

If the user chooses not to accept the transaction, by activating the NO key, the same process described above will be performed, however, with the information of the user's option was for NO, thus an answer is generated and submitted to the central host servers of the organization with the digital signature produced by the Smart Card, therefore, charactering an unequivocal answer with the user's NO.

When the central host servers receive this answer, they will notify the transaction's remote point of origin that the user has not accepted the transaction. This will be typically the case of a fraudster trying to make use of a counterfeit card or trying to purchase something through the Internet using information improperly collected from the user's credit card.

If the user keeps the special purpose device turned off or does not activate the Smart Card by means of the correct PIN, the central gateway servers provided by the invention, after waiting a certain standard elapsed time defined by the organization, will return a message to the central host servers of the organization, which will in turn send a message to the transaction point of origin denying the approval of the transaction to be carried out, indicating a code that shows why it has been denied. This will also be typically the case of a fraudster trying to make use of a counterfeit card or trying to purchase something through the Internet using information improperly collected from the user's credit card.

If the digital signature verification of the message received by the cryptography central servers provided by the invention shows that it is not correct, the transaction will also be denied and the remote point will be informed of why it was denied.

One aspect of the invention is a SYSTEM TO AUTHENTICATE RELATIONSHIPS BY ELECTRONIC MEANS, between a user and an organization, in which the user takes non-deniable responsibility for any decision or transaction carried on through said relationships, aiming in this way at reduction of fraud possibilities, characterized by its architecture comprising:

THE FOLLOWING ELEMENTS AND FUNCTIONS—A CENTRAL GATEWAY SERVER (2) with relay, communication and cryptographic functions, holding for this specific function its own private key and digital certificate, a DATA BASE SERVER (3) that ties the user's identification, used by the organization, to his/her mobile phone number and to his/her digital certificate, a PERMANENT LINK (4) between the CENTRAL GATEWAY SERVER (2) and the central servers of the organization, the services offered by a PUBLIC MOBILE OPERATOR NETWORK (5) to be used by the CENTRAL GATEWAY SERVER (2) to communicate with an USER'S MOBILE PHONE OR SMARTPHONE (6), a SPECIFIC APPLICATION SOFTWARE to be downloaded to the USER'S MOBILE PHONE OR SMARTPHONE (6), that should be Bluetooth enabled, a SPECIAL PURPOSE DEVICE (7), Bluetooth wireless enabled, with an imbedded application software, to be carried by the USER (1) in addition to his/her phone or smartphone (6), and that, when turned on by the user, by pressing an ON/OFF button available on it (17), will communicate via Bluetooth (8) with the USER'S PHONE OR SMARTPHONE (6), and an User's PKI JAVA SMART CARD (16), of the size and format of a SIM card, containing special purpose java applications and an USER'S PRIVATE KEY AND DIGITAL CERTIFICATE and the DIGITAL CERTIFICATE OF SAID GATEWAY SERVER, having the certificates been issued by a TRUSTED CERTIFICATION AUTHORITY.

THE UTILIZATION OF THE FOLLOWING TECHNOLOGIES—PKI—Public Key Infrastructure, plus symmetric encrypting technology, digital signatures and tamper proof smart cards, deployed by functions performed by the CENTRAL GATEWAY SERVER (2) and the SMART CARD (16), SPECIAL PURPOSE DEVICE (7), and USER'S MOBILE PHONE OR SMARTPHONE (6), such as to guarantee the safe and integrity protected USER authentication, through the usage of two factor authentication, something the user has and something the user knows, comprised of several items the USER has such as his/her SPECIAL PURPOSE DEVICE (7), his/her SMART CARD (16), his/her PRIVATE KEY AND DIGITAL CERTIFICATE, and the DIGITAL CERTIFICATE of the CENTRAL GATEWAY SERVER (2) stored in the SMART CARD (16), his/her MOBILE PHONE (6) NUMBER and his/her DIGITAL CERTIFICATE stored at the DATA BASE SERVER (3) maintained by the organization, the SPECIFIC APPLICATION SOFTWARE to be downloaded to his/her MOBILE PHONE OR SMARTPHONE (6), and the secret PIN NUMBER, of his/her exclusive responsible knowledge, to have access and activate the SMART CARD (16) to become operational.

THE FOLLOWING INPUT INTERFACES—at the central level the input interface is provided through the PERMANENT LINK (4) between the CENTRAL GATEWAY SERVER (2), and the central servers of the organization, such that at the occurrence of an event or transaction that the organization wishes to be additionally authenticated or confirmed, a message is sent to the system containing the identification of the organization, a message number ID, the user's identification, his/her mobile phone number, his/her digital certificate and data characterizing such event or transaction, to request and wait for the authentication and non-deniable confirmation to be obtained from the user by the system, and at the USER's level by his/her turning on his SPECIAL PURPOSE DEVICE (7) by pressing the ON/OFF button available on it and by his/her input at his/her MOBILE PHONE OR SMARTPHONE (6) of the correct PIN number tied to his/her SMART CARD (16), and of his/her response to the prompt question he/she receives at the screen of his/her MOBILE PHONE OR SMARTPHONE (6) through a YES or NO, plus a CONFIRMATION, information.

THE FOLLOWING OUTPUT INTERFACES‘at the USER's level the output interface is provided by a prompt question showing data characterizing the event or transaction and a request for a YES or NO, plus a CONFIRMATION, information to be provided by the USER, and a at the central level through the PERMANENT LINK (4) between the CENTRAL GATEWAY SERVER (2), and the central servers of the organization, by which a message is returned to the central servers of the organization containing the message number ID, the user's identification, and the result of the information requested from the USER (1).

THE FOLLOWING IMPLICATIONS TO THE EXISTING SYSTEM OF RELATIONSHIPS BY ELECTRONIC MEANS—at the level of the organization central servers there is the need of the introduction of a DATA BASE SERVER (3) that ties the user's identification, used by the organization, to his/her mobile phone number and to his/her digital certificate, and a change in the application code of the central servers so that they will generate a message, send it to the claimed invented system and, wait for its response to take the proper action, of approving or rejecting the transaction or event they originally received through the EXISTING SYSTEM OF RELATIONSHIPS BY ELECTRONIC MEANS, in accordance to the criteria defined by the organization, and at the USER interface level (10), being it, as the case may be, a POS at a merchant location, a PC through the Internet or intranet, a fixed or mobile phone or a fax machine, and a ATM, there is NO CHANGE AT ALL REQUIRED.

Another aspect of the invention is a METHOD TO AUTHENTICATE RELATIONSHIPS BY ELECTRONIC MEANS, between a user and an organization, in which the user takes non-deniable responsibility for any decision or transaction carried on through said relationships, aiming in this way at reduction of fraud possibilities, characterized by, the following steps:

The USER (1) turns on his SPECIAL PURPOSE DEVICE (7) by pressing the ON/OFF button available on it (17) and activates it by keying in his PIN number on his mobile phone or smartphone (6), as requested by it.

The Central servers of the organization (12), when they receive the request for the approval of a transaction or event requested by the user (1), through the interface offered (10) by the existing system of RELATIONSHIPS BY ELECTRONIC MEANS, and in accordance to the criteria defined by the organization, they send a message to CENTRAL GATEWAY SERVER (2) through the PERMANENT LINK (4) containing the identification of the organization, a message number ID, user's identification, his/her mobile phone number, his/her digital certificate and data characterizing such transaction or event, and wait for the response from CENTRAL GATEWAY SERVER (2) before approving or denying the received request.

The CENTRAL GATEWAY SERVER (2) generates a cryptographic challenge, including a double digital signature of the message received from the servers of the organization (12) using its own private key and the user's certificate contained in the message received through the PERMANENT LINK (4), and sends the message, properly encrypted through the network of a mobile operator (5) to the user's mobile phone or smartphone (6).

The USER (1) then takes non-deniable responsibility for the transaction or event, which is informed at his/her mobile phone or smartphone (6), by showing the organization identification, date and value or nature of the transaction or event, choosing to input YES or NO, and CONFIRMATION (9) at his/her MOBILE PHONE OR SMARTPHONE (6), in order to register his/her decision, and, as the case may be, to enter again his PIN number.

The USER's statement (9) plus the transaction or event information is then sent, via the Bluetooth link (8), to the SPECIAL PURPOSE DEVICE (7),so that the PKI JAVA SMART CARD (16), held in its interior, may perform the necessary cryptographic operations in order that a secure response message may be generated with the YES or NO user's decision, being it digitally signed using the user's private key and the public key of the CENTRAL GATEWAY SERVER (2), sending it back then to the user's mobile phone or smartphone (6)

The MOBILE PHONE OR SMARTPHONE (6) then sends the response message back to the CENTRAL GATEWAY SERVER (2), which will do the appropriate checking on the received digital signatures and if they are OK, will send the response message, through PERMANENT LINK (4), to the central servers of the organization (12).

The central servers of the organization (12) will then send back to the remote USER INTERFACES (10) the approval or not of the transaction or event that was supposedly requested by the USER (1).

If no response is obtained, by CENTRAL GATEWAY SERVER (2), after a certain defined elapsed time, or there is any error regarding the cryptographic checking procedures, it will send a message back to the central servers of the organization (12) indicating this occurrences, so that they may take the proper pre-defined action for these situation, approving or rejecting the received request from its USER available interfaces (10).

Yet another aspect of the invention is a DEVICE TO AUTHENTICATE RELATIONSHIPS BY ELECTRONIC MEANS, between an USER and an organization, characterized by being a SPECIAL PURPOSE DEVICE (7), Bluetooth wireless enabled containing the technology, being it of hardware and software nature, necessary to read/write to a PKI JAVA SMART CARD (16) to establish connection via Bluetooth (8) to the USER'S MOBILE PHONE OR SMARTPHONE (6), to store and execute the application software provided by the invention in order to supply the required defined functionality, to store temporary data it has received and processed, so that it may send it back to the USER'S MOBILE PHONE (6) when requested, and also comprising an ON/OFF button (17), a LED to indicate when it is ON (18), and a battery to supply the energy it needs to operate.

The final result obtained is an extremely simple, safe and practical users' authentication process, using various currently existing technologies in a new manner, characterizing new possibilities of actually reducing frauds, and, in consequence, an actual possible increase of new businesses via the Internet and wireless communication mobile devices, by the fact that people may acquire a new and growing trust to carry out their purchases and transactions via the Internet.

1. A system for additionally authenticating existing relationships by electronic means between a user and an organization, in which the user takes non-deniable responsibility for any decision or transaction carried on through said relationships, thereby reducing the possibility of fraud, comprising:
a central gateway server having at least one computer processor, a computer memory, and at least one network interface,
said computer memory containing:
a private key associated with said central gateway server,
a digital certificate associated with said central gateway server, said digital certificate being from a trusted certification authority, and
computer processor executable instructions for communicating and relaying data through said at least one network interface and for encrypting and decrypting data with said private key and said digital certificate;
a data base server having at least one computer processor, a computer memory, and at least one network interface connecting said data base server to at least one existing central server of said organization,
said computer memory containing:
data that relates a unique identifier associated with said user with a mobile phone number associated with said user and a digital certificate associated with said user;
a permanent link between said at least one network interface of said central gateway server and said at least one network interface of said at least one existing central server of said organization
a mobile phone associated with said user, the mobile phone having at least one computer processor, a computer memory, at least one cellular network interface and at least one additional wireless interface to other wireless devices;
a mobile operator network capable of establishing data communication between said central gateway server and said mobile phone;
a special purpose device having at least one computer processor, a computer memory, a data communication link with said mobile phone, and a smart card containing:
a data communication link with said special purpose device, and
a computer memory containing:
a private key associated with said user,
a digital certificate associated with said user, said digital certificate being from a trusted certification authority,
a digital certificate associated with said central gateway server, said digital certificate being from a trusted certification authority and
computer processor executable instructions for encrypting and decrypting data;
wherein the at least one computer memory of the at least one existing central server associated with the said organization contains computer processor executable instructions for requesting the data base server to return, when provided with the unique identifier associated with said user, the mobile phone number and a digital certificate associated with said user;
wherein the computer memory of the data base server, contains computer executable instructions for returning the mobile phone number and a digital certificate associated with said user, on the basis of the unique identifier associated with said user, when requested by one existing central server associated with the said organization;
wherein the at least one computer memory of the at least one existing central server associated with said organization contains computer processor executable instructions for sending a message requiring an authenticated and confirmed response from the user through said invented system, and for receiving said authenticated and confirmed response;
wherein the computer memory of the central gateway server contains computer executable instructions for encrypting and communicating said message requiring an authenticated and confirmed response from said user through said mobile phone associated with said user and for receiving and decrypting said authenticated and confirmed response from said mobile phone associated with said user.
wherein the computer memory of said mobile phone contains computer executable instructions for said mobile phone to communicate with said central gateway server through said mobile operator;
wherein the computer memory of said mobile phone contains computer executable instructions for said mobile phone to communicate with said special purpose device, for displaying messages to said user, and for receiving the response provided by said user, being it a personal identification number, a yes for accepting or a no for rejecting the details of the transaction message received at said mobile phone, and taking a non-deniable responsibility for that by confirming his decision.

2. A method for additionally authenticating existing relationships by electronic means between a user and an organization, in which the user takes non-deniable responsibility for any decision or transaction carried on through said relationships, thereby reducing the possibility of fraud, in a system comprising:
a central gateway server having at least one computer processor, a computer memory, and at least one network interface,
said computer memory containing:
a private key associated with said central gateway server,
a digital certificate associated with said central gateway server, said digital certificate being from a trusted certification authority, and
computer processor executable instructions for communicating and relaying data through said at least one network interface and for encrypting and decrypting data with said private key and said digital certificate;
a data base server having at least one computer processor, a computer memory, and at least one network interface connecting said data base server to at least one existing central server of said organization,
said computer memory containing:
data that relates a unique identifier associated with said user with a mobile phone number associated with said user and a digital certificate associated with said user;
a permanent link between said at least one network interface of said central gateway server and said at least one network interface of said at least one existing central server of said organization
a mobile phone associated with said user, the mobile phone having at least one computer processor, a computer memory, at least one cellular network interface and at least one additional wireless interface to other wireless devices;
a mobile operator network capable of establishing data communication between said central gateway server and said mobile phone;
a special purpose device having at least one computer processor, a computer memory, a data communication link with said mobile phone, and a smart card containing:
a data communication link with said special purpose device, and
a computer memory containing:
a private key associated with said user,
a digital certificate associated with said user, said digital certificate being from a trusted certification authority,
a digital certificate associated with said central gateway server, said digital certificate being from a trusted certification authority and
computer processor executable instructions for encrypting and decrypting data;
the steps of the method comprising:
said user turning on the special purpose device and activating it by keying in a personal identification number on the mobile phone of said user,
said user submitting the approval of his/her request to the existing central server of said organization through the existing user interface level offered by said organization;
receiving in the at least one existing central server of said organization a request from said user, said request being for the approval of a transaction or event requested by said user, through the existing user interface level offered by said organization;
generating and sending a message from the at least one existing central server of said organization to the central gateway server of said invented system through the permanent link containing an identification of the organization, a message number ID, an identification of the user, the mobile phone number of the user, the digital certificate of the user, and data characterizing the request for the approval of a transaction or event requested by the user;
generating in the central gateway server a cryptographic challenge, including a double digital signature of the message received from the at least one existing central server of said organization with the private key associated with the central gateway server and the public key contained in the digital certificate of the user, thereby encrypting the message from the at least one central server;
sending the encrypted message from the central gateway server through the mobile operator network to the mobile phone of the user;
waiting for the mobile phone of the user to communicate with the special purpose device together with the smart card to decrypt the message using a process based on validating the double signature of the message using the public key contained in the digital certificate of said user and the private key of said central gateway server;
waiting for the mobile phone of the user to present the decrypted message, including the identification of the organization and information regarding the nature of the transaction or event;
waiting for the user to input and confirm a response to the information presented to the user by the mobile phone;
waiting for the mobile phone to transmit the response of the user in addition to information regarding the transaction or event to the special purpose device;
waiting for the special purpose device, together with the smart card to perform cryptographic operations to generate a secure message containing the response from the user, the message being digitally signed using the private key of the user and the public key of the central gateway server;
waiting for the mobile phone to transmit the secure digitally signed message back to the central gateway server through the mobile operator network;
receiving the secure digitally signed message in the central gateway server and determining if the secure digitally signed message is authentic;
if the secure digitally signed message is not authentic, then sending an error message to the at least one existing central server of said organization;
if no response from said user is received in a pre-defined time interval, then sending an error message to the at least one existing central server of said organization;
if the secure digitally signed message is authentic, sending a message with the response of said user through said permanent link to the at least one existing central server of said organization;
receiving the message at the existing central server of said organization and identifying the nature of the received message;
if it is an error message then sending in sequence a message denying the requested approval back to the existing user level interface offered by said organization from which it came from;
if it is a message with a no from said user, then sending in sequence a message denying the requested approval back to the existing user level interface offered by said organization from which it came from;
if it is a message with a yes from said user, then sending in sequence a message approving the requested approval back to the existing user level interface offered by said organization from which it came from.

3. Equipment for use in electronically authenticating relationships between a user and an organization, comprising:
a special purpose device comprising:
at least one computer processor;
a computer memory;
a data communication interface enabling the special purpose device to establish a data communication link with a mobile phone;
hardware, and computer executable instructions in the computer memory, adapted to enable the special purpose device to read and write data to a PKI (public key infrastructure) enabled JAVA smart card, with the dimensions of a standard SIM card inserted in the special purpose device and, in conjunction with said smart card, to encrypt and decrypt data sent to and received from the mobile phone;
a button to turn said special purpose device on or off;
a light emitting element adapted for indicating when the device is on; and
a battery for supplying energy to the special purpose device.
wherein the data communication link between the mobile phone and the special purpose device is wireless;
wherein the said special purpose device further contains computer executable instructions to verify whether the personal identification number transmitted from the mobile phone is correct and to operate in conjunction with the mobile phone and the smart card to encrypt and decrypt data only if the transmitted personal identification number is correct;
wherein the said special purpose device further contains computer executable instructions to perform the digital signatures validation and creation, in conjunction with said smart card, and in accordance to the steps mentioned in said invented method;
wherein said smart card contains the private key and digital certificate of said user, and the digital certificate associated with said central gateway server.
